(19) United States
(12) Patent Application Publication
(10) Pub. No.: US 2023/0213170 A1
(43) Pub. Date: Jul. 6, 2023

(54) BACKLIGHT MODULE AND DISPLAY DEVICE

(71) Applicant: Innolux Corporation, Miao-Li County (TW)

(72) Inventors: Jia-Huei Lin, Miao-Li County (TW); Chin-Lung Ting, Miao-Li County (TW); Li-Wei Mao, Miao-Li County (TW); Fang-Ho Lin, Miao-Li County (TW); Chieh Ying Chen, Miao-Li County (TW)

(73) Assignee: Innolux Corporation, Miao-Li County (TW)

(21) Appl. No.: 18/181,503

(22) Filed: Mar. 9, 2023

Related U.S. Application Data
(63) Continuation of application No. 17/341,399, filed on Jun. 8, 2021.
(60) Provisional application No. 63/047,917, filed on Jul. 3, 2020.
(60) Provisional application No. 63/066,825, filed on Aug. 18, 2020.

(30) Foreign Application Priority Data
Jan. 6, 2021 (CN) 202110012017.9

(51) Int. Cl. F21V 7/05

(52) U.S. Cl. CPC F21V 7/05; F21Y 2115/10

(57) ABSTRACT

A backlight module includes a substrate, light-emitting elements, circuit elements and a reflective sheet. The light-emitting elements are bonded onto the substrate. The circuit elements are bonded onto the substrate and electrically connected to the light-emitting elements. At least four of the light-emitting elements are disposed around one of the circuit elements. The reflective sheet is disposed on the substrate and has first openings exposing the light-emitting elements and protrusions. The protrusions corresponds to the circuit elements and cover the circuit elements. One of the protrusions has an opening formed of two crossing slits. Extending directions of the two crossing slits do not cross the at least four of the light-emitting elements. The one of the protrusions corresponds to the one of the circuit elements. The at least four of the light-emitting elements are closer to the one of the circuit elements than other of the light-emitting elements.

### CROSS-REFERENCE TO RELATED APPLICATION

This application is a continuation application of and claims the priority benefit of a prior application Ser. No. 17/341,399, filed on Jun. 8, 2021. The prior application Ser. No. 17/341,399 claims the priority benefit of U.S. provisional application Ser. No. 63/047,917, filed on Jul. 3, 2020, U.S. provisional application Ser. No. 63/066,825, filed on Aug. 18, 2020, and China application serial no. 202110012017.9, filed on Jan. 6, 2021. The entirety of each of the above-mentioned patent applications is hereby incorporated by reference herein and made a part of this specification.

### BACKGROUND

### Technical Field

The disclosure relates to a backlight module and a display device, and more particularly, to a backlight module and a display device which can improve the mura or exhibit a more uniform brightness.

### Description of Related Art

Display panels have been widely applied to electronic devices such as mobile phones, televisions, monitors, tablet computers, car displays, wearable devices, and desktop computers. With the vigorous development of electronic products, the requirements for the display quality of electronic products also increase, such that the electronic devices used for display are constantly improving towards larger or higher-resolution display effects.

### SUMMARY

The disclosure provides a backlight module and a display device which can improve the mura or exhibit a more uniform brightness.

According to an embodiment of the disclosure, a backlight module includes a substrate, a plurality of light-emitting elements, a plurality of circuit elements, and a reflective sheet. The light-emitting elements are bonded onto the substrate. The circuit elements are bonded onto the substrate and electrically connected to the light-emitting element. At least four of the light-emitting elements are disposed around one of the circuit elements. The reflective sheet is disposed on the substrate and has a plurality of first openings. The first openings at least expose the light-emitting elements. The reflective sheet further includes a plurality of protrusions. The protrusions are disposed corresponding to positions of the circuit elements, and the protrusions cover the circuit elements. One of the protrusions has an opening, and the opening is formed of two crossing slits. Extending directions of the two crossing slits are respectively parallel to extending directions of two edges of the circuit elements, and the extending directions of the two crossing slits do not cross the at least four of the light-emitting elements in a top view of the backlight module. The one of the protrusions corresponds to the one of the circuit elements in the top view of the backlight module. The at least four of the light-emitting elements are closer to the one of the circuit elements than other of the light-emitting elements.

According to an embodiment of the disclosure, a display device includes the above backlight module and a display panel disposed on the backlight module.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic perspective view showing a display device according to an embodiment of the disclosure.

FIG. 2A is a schematic top view showing a protrusion of the display device of FIG. 1.

FIG. 2B to FIG. 2D are schematic top views showing the protrusion of the display device according to multiple embodiments of the disclosure.

FIG. 3 is a schematic perspective view showing a display device according to another embodiment of the disclosure.

### DESCRIPTION OF THE EMBODIMENTS

The disclosure may be understood by referring to the following detailed description with reference to the accompanying drawings. It is noted that for comprehension of the reader and simplicity of the drawings, in the drawings of the disclosure, only a part of the electronic device is shown, and specific components in the drawings are not necessarily drawn to scale. Moreover, the quantity and the size of each component in the drawings are only schematic and are not intended to limit the scope of the disclosure.

In the following specification and claims, the terms “having”, “including”, “comprising” etc. are open-ended terms, so they should be interpreted to mean “including but not limited to . . . ”.

It should be understood that when a component or a film layer is described as being “on” or “connected to” another component or film layer, it may be directly on or connected to the another component or film layer, or there is an intervening component or film layer therebetween (i.e., being indirectly on or indirectly connected). Conversely, when a component or film layer is described as being “directly on” or “directly connected to” another component or film layer, there is no intervening component or film layer therebetween.

The terms such as “first”, “second”, “third”, etc. may be used to describe components, but the components should not be limited by these terms. The terms are only intended to distinguish a component from another component in the specification. It is possible that the claims do not use the same terms and replace the terms with “first”, “second”, “third” etc. according to the sequence declared in the claims. Accordingly, in the specification, a first component may be a second component in the claims.

In some embodiments of the disclosure, unless specifically defined, terms related to bonding and connection such as “connect”, “interconnect”, etc. may mean that two structures are in direct contact, or that two structures are not in direct contact and another structure is provided therebetween. The terms related to bonding and connection may also cover cases where two structures are both movable or two structures are both fixed. In addition, the term “couple” includes any direct and indirect electrical connection means.

In the disclosure, the length and width may be measured by an optical microscope, and the height and thickness may be measured based on a cross-sectional image in an electron microscope, but the disclosure is not limited thereto. In addition, there may be a certain error between any two values or directions used for comparison.

In the disclosure, the electronic device may include a display device, an antenna device (e.g., a liquid crystal antenna), a sensing device, a light-emitting device, a touch device, or a splicing device, but is not limited thereto. The electronic device may include a bendable or flexible electronic device. The shape of the electronic device may be rectangular, circular, polygonal, a shape with curved edges, or other suitable shapes. The display device may include, for example, a light-emitting diode (LED), a liquid crystal, a fluorescence, a phosphor, a quantum dot (QD), other suitable materials, or a combination of the above, but is not limited thereto. The light-emitting diode may include, for example, an organic light-emitting diode (OLED), an inorganic light-emitting diode (LED), a mini LED, a micro LED or a quantum dot LED (e.g., QLED or QDLED), other suitable materials, or any combination of the above, but is not limited thereto. The display device may include, for example, a splicing display device, but is not limited thereto. The antenna device may include, for example, a liquid crystal antenna, but is not limited thereto. The antenna device may include, for example, an antenna splicing device, but is not limited thereto. It is noted that the electronic device may be any combination of the above, but is not limited thereto. The electronic device may have peripheral systems such as a driving system, a control system, a light source system, a rack system, etc. to support a display device, an antenna device, or a splicing device. Hereinafter, a display device will be described to illustrate the content of the disclosure, but the disclosure is not limited thereto.

In the disclosure, the features in multiple different embodiments descried below may be replaced, combined, and/or mixed to form other embodiments without departing from the spirit of the disclosure. The features of the embodiments may be arbitrarily mixed and combined as long as they do not depart from or conflict with the spirit of the disclosure.

Reference will now be made in detail to the exemplary embodiments of the disclosure, examples of which are illustrated in the accompanying drawings. Whenever possible, the same reference numerals are used to represent the same or similar parts in the accompanying drawings and description.

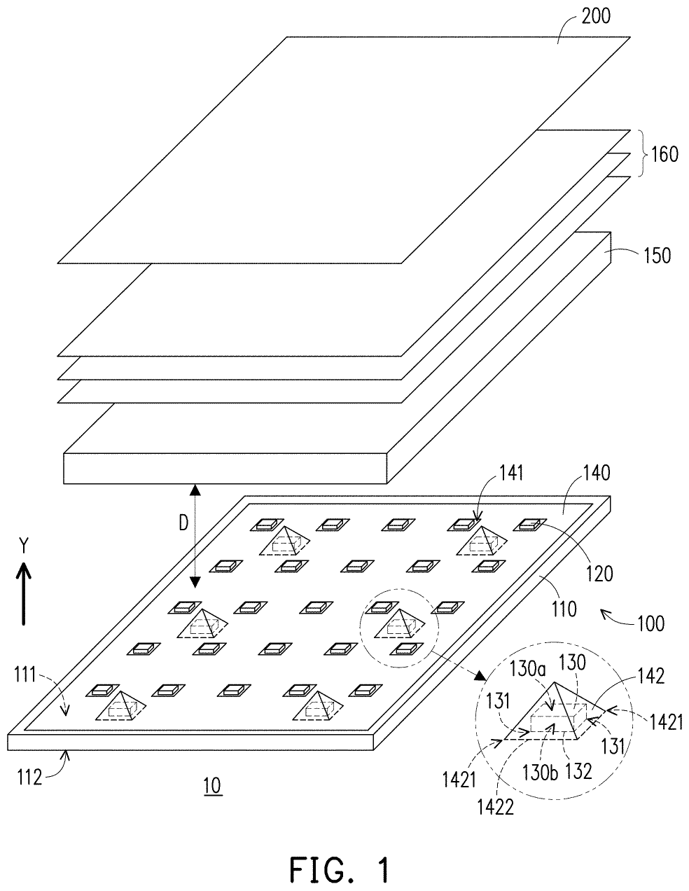

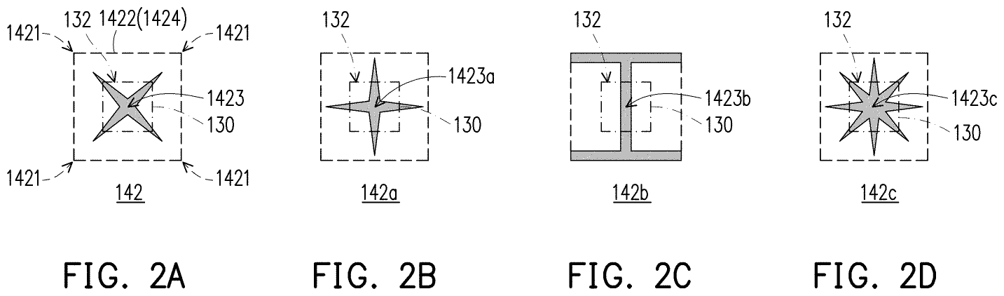

FIG. 1 is a schematic perspective view showing a display device according to an embodiment of the disclosure. FIG. 2A is a schematic top view showing a protrusion of the display device of FIG. 1. FIG. 2B to FIG. 2D are schematic top views showing the protrusion of the display device according to multiple embodiments of the disclosure. Referring to FIG. 1 first, a display device 10 of this embodiment may include a backlight module 100 and a display panel 200. The display panel 200 is disposed on the backlight module 100 so that the backlight module 100 may provide light to the display panel 200. In some embodiments, the backlight module 100 may be a direct-type backlight module, so that the light emitted by the backlight module 100 can be transmitted toward the display panel 200.

Referring to FIG. 1 again, the backlight module 100 of this embodiment may include a substrate 110, a light-emitting element 120, a circuit element 130, and a reflective sheet 140. In this embodiment, the substrate 110 has a first surface 111 and a second surface 112 opposite to the first surface 111. The substrate 110 may be, for example, a circuit board and may include a single layer or multiple layers of circuit wirings. The substrate 110 may also be, for example, an active driving substrate and may include driving circuits (not shown) such as transistors, scan lines, and data lines to thereby drive the light-emitting element 120 to emit light. The substrate 110 may include a rigid substrate, a flexible substrate, or a combination of the above. For example, the material of the substrate 110 may include glass, quartz, sapphire, ceramics, polycarbonate (PC), polyimide (PI), polyethylene terephthalate (PET), other suitable substrate materials, or a combination of the above, but is not limited thereto.

In this embodiment, the light-emitting element 120 may be bonded onto the first surface 111 of the substrate 110. Specifically, the light-emitting element 120 may include an electrode pad (not shown) disposed on the light-emitting element 120, and the substrate 110 may include a pad (not shown) and another pad (not shown) disposed on the substrate 110. The light-emitting element 120 may be bonded onto the substrate 110 via the pad, so that the light-emitting element 120 can be electrically connected to the substrate 110 via the electrode pad and the pad. In this embodiment, the light-emitting element 120 may include, for example, light-emitting diodes of different colors, such as a red light-emitting diode, a green light-emitting diode, a blue light-emitting diode, and/or a white light-emitting diode, but is not limited thereto. The light-emitting element 120 may also include a blue light-emitting diode or an ultraviolet light-emitting diode with a light conversion material, and the light conversion material may include, for example, a quantum dot, a fluorescence, a phosphor, other suitable materials, or a combination of the above, but is not limit thereto.

In this embodiment, the circuit element 130 may be bonded onto the first surface 111 of the substrate 110 and electrically connected to the light-emitting element 120. Specifically, the circuit element 130 may include, for example, a completed non-light-emitting element such as a driving IC, a gate driver, a capacitor, and/or a resistor, but is not limited thereto. The circuit element 130 may include, for example, an integrated circuit manufactured by a semiconductor process, or an active driving circuit manufactured by a thin film process. The circuit element 130 may be bonded onto and electrically connected to the substrate 110 via the another pad of the substrate 110, so that the circuit element 130 can be electrically connected to the light-emitting element 120 via the another pad of the substrate 110 and the circuit wiring or driving circuit in the substrate 110, so as to control and drive the light-emitting element 120 to emit light. In this embodiment, since the circuit element 130 and the light-emitting element 120 are both disposed on the same surface (e.g., the first surface 111) of the substrate 110, compared to a backlight module in which the circuit element and the light-emitting element are respectively disposed on different surfaces (e.g., a first surface and a second surface opposite to each other) of the substrate, the backlight module 100 of this embodiment may have a smaller thickness and may conform to a thin design. In this embodiment, at least four of the light-emitting elements 120 are disposed around one of the circuit elements 130, and the at least four of the light-emitting elements 120 are closer to the one of the circuit elements 130 than other of the light-emitting elements 130.

In addition, in this embodiment, the circuit element 130 has a top surface 130a facing away from the first surface 111 of the substrate 110 and a side surface 130b. The height of the circuit element 130 is, for example, greater than the height of the light-emitting element 120, but is not limited thereto. The height of the circuit element 130 is, for example, the maximum height of the circuit element 130 measured along a normal direction Y of the substrate 110, and the height of the light-emitting element 120 is, for example, the maximum height of the light-emitting element 120 measured along the normal direction Y of the substrate 110.

In this embodiment, the reflective sheet 140 may be disposed on the first surface 111 of the substrate 110, so that the reflective sheet 140 can cover a non-light emitting region and/or a non-light-emitting element on the substrate 110. The material of the reflective sheet 140 may include, for example, a white polyester, other suitable reflective materials, or a combination of the above, but is not limited thereto. The reflective sheet 140 has a first opening 141 and a protrusion 142. The first opening 141 may at least expose the light-emitting element 120. The protrusion 142 may be a portion of the reflective sheet 140, the protrusion 142 and the reflective sheet 140 may be integrally formed, and the protrusion 142 and the reflective sheet 140 may be seamlessly connected, but the disclosure is not limited thereto. The protrusion 142 may be disposed corresponding to the position of the circuit element 130, so that the protrusion 142 can cover the circuit element 130 and at least a portion of the surface (e.g., the top surface 130a and the side surface 130b) of the circuit element 130 can be made reflective due to the coverage of the protrusion 142. Accordingly, the mura resulting from the exposure of the circuit element of the display device can be improved, or the display device can exhibit a more uniform brightness. In some embodiment, one of the protrusions 142 corresponds to one of the circuit elements 130 in the top view of the backlight module 100.

For example, in this embodiment, the shape of the circuit element 130 is, for example, a square, and the bottom of the circuit element 130 has four vertices 131 and four edges 132. The shape of the protrusion 142 is, for example, a pyramid shape, and the bottom of the protrusion 142 also has four vertices 1421 and four edges 1422. The four edges 1422 of the protrusion 142 may respectively correspond to and be substantially parallel to the four edges 132 of the circuit element 130, and the four vertices 1421 of the bottom of the protrusion 142 may respectively correspond to the four vertices 131 of the circuit element 130, so that the protrusion 142 can better cover the circuit element 130. Furthermore, when the edges 1422 of the protrusion 142 can respectively correspond to and be substantially parallel to the edges 132 of the circuit element 130, the heat generated by the circuit element 130 can be more evenly transferred to the edges 1422 of the protrusion 142 through the edges 132, so as to prevent occurrence of folds at the edges 1422 of the protrusion 142 due to uneven heating.

Referring to FIG. 2A, in the schematic top view of the protrusion 142 of this embodiment, the protrusion 142 further has an opening 1423 and a perforated line 1424. The opening 1423 may have an X-shaped pattern formed of two crossing slits. The extending directions of the two crossing slits are both different from the extending directions of the four edges 132 of the circuit element 130. The extending directions of the two crossing slits cross the four vertices 1421 of the protrusion 142. Therefore, the protrusion 142 can better cover the circuit element 130.

In addition, in this embodiment, the perforated line 1424 is provided corresponding to the edges 1422 of the protrusion 142. The perforated line 1424 may be regarded as multiple discontinuous indentations formed on the edges 1422 of the protrusion 142, as shown by the dotted lines in FIG. 2A. In this embodiment, with the design of the perforated line 1424 (i.e., multiple discontinuous indentations), the edges 1422 of the protrusion 142 can be more closely covered or fixed on the substrate 110. For example, in the case of a protrusion without a perforated line, when the protrusion is arched due to heating of the circuit element, the arching range may expand beyond the edges of the protrusion and extend to the reflective sheet around the opening, so that the light-emitting element in the opening is shielded by the arched reflective sheet, thus resulting in mura. In contrast, in the case of the protrusion 142 provided with the perforated line 1424 in this embodiment, with the perforated line 1424, the edges 1422 of the protrusion 142 can be reliably fixed on the substrate 110. Therefore, the arching range does not expand beyond the edges 1422 of the protrusion 142, which thus reduces shielding of the light-emitting element and occurrence of the mura resulting from the arching of the reflective sheet.

Although the shape of the protrusion 142 of this embodiment may be, for example, a pyramid shape, and the opening 1423 of the protrusion 142 may have, for example, an X-shaped pattern formed of two crossing slits, the disclosure does not limit the shape of the protrusion, the number of slits, and the pattern of the opening. In some embodiments, as shown in FIG. 2B, the shape of a protrusion 142a may also be a two-by-two-grid shape, and an opening 1423a of the protrusion 142a may have, for example, a cross pattern formed of two crossing slits. In FIG. 2B, extending directions of the two crossing slits are respectively parallel to extending directions of two edges 132 of the circuit elements 130, and the extending directions of the two crossing slits do not cross the at least four of the light-emitting elements 120 in a top view of the backlight module 100. In some embodiments, as shown in FIG. 2C, the shape of a protrusion 142b may also be an I-shape, and an opening 1423b of the protrusion 142b may have, for example, an I-shaped pattern formed of three crossing slits. In some embodiments, as shown in FIG. 2D, the shape of a protrusion 142c may also be a star-shape, and an opening 1423c of the protrusion 142c may have, for example, a star-shaped pattern formed of four crossing slits.

Referring to FIG. 1 again, in this embodiment, the backlight module 100 may further include a diffuser 150 and an optical film 160. The diffuser 150 is disposed on the substrate 110 and located between the display panel 200 and the substrate 110. A distance D is present between the diffuser 150 and the substrate 110. The distance D is, for example, less than or equal to 5 millimeters (mm), so that the backlight module 100 and the display device 10 of this embodiment can conform to a thin design, but the disclosure is not limited thereto. The distance D is, for example, the maximum distance measured along the normal direction Y of the substrate 110 between the diffuser 150 and the substrate 110. The optical film 160 is disposed on the diffuser 150 and located between the display panel 200 and the diffuser 150. The optical film 160 may include a prism sheet, a diffusion film, and a brightness enhancement film, but is not limited thereto.

In brief, in the backlight module 100 and the display device 10 of the embodiment of the disclosure, since the circuit element 130 and the light-emitting element 120 are both disposed on the same surface (e.g., the first surface 111) of the substrate 110, compared to a backlight module in which the circuit element and the light-emitting element are respectively disposed on different surfaces (e.g., a first surface and a second surface opposite to each other) of the substrate, the backlight module 100 and the display device 10 of this embodiment may have a smaller thickness or may conform to a thin design. In addition, the approach of covering the circuit element 130 by the protrusion 142 of the reflective sheet 140 can improve the mura of the display device resulting from the exposure of the circuit element or can provide a more uniform brightness in the display device.

Other embodiments will be provided and described below. It is noted herein that the reference numerals and part of the descriptions of the above embodiment apply to the following embodiments, where the same numerals are used to represent the same or similar components, and descriptions of the same technical contents are omitted. Reference may be made to the above embodiment for the descriptions of the omitted contents, which will not be repeated in the following embodiments.

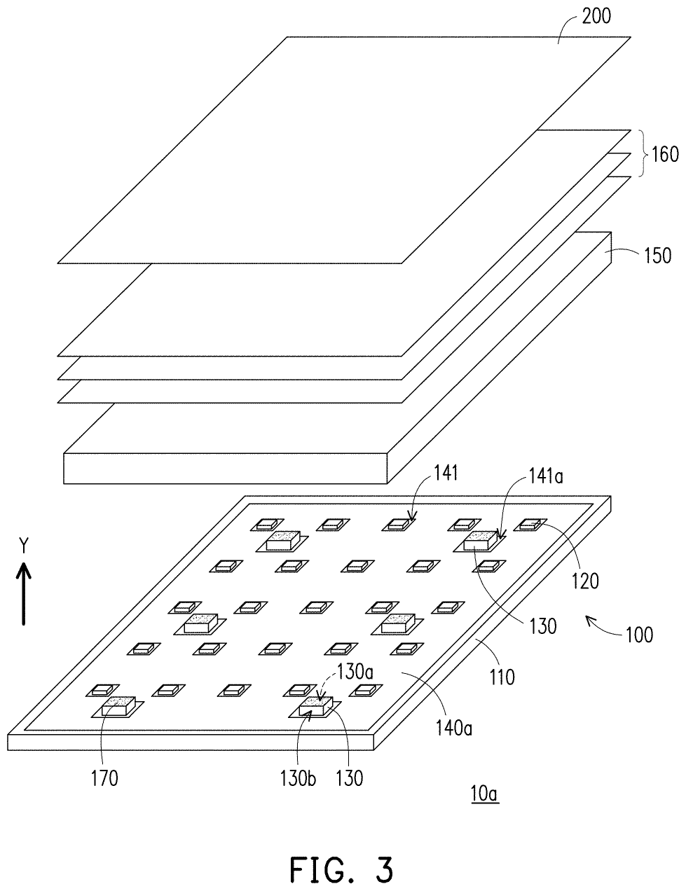

FIG. 3 is a schematic perspective view showing a display device according to another embodiment of the disclosure. Referring to FIG. 1 and FIG. 3 at the same time, a display device 10a of this embodiment is substantially similar to the display device 10 of FIG. 1, so the same and similar components in the two embodiments will not be repeatedly described herein. The display device 10a of this embodiment is different from the display device 10 mainly in that, in the display device 10a of this embodiment, a reflective sheet 140a does not have a protrusion, but the reflective sheet 140a further has a second opening 141a.

Specifically, referring to FIG. 3, the reflective sheet 140a has the second opening 141a, and the second opening 141a may expose the top surface 130a and the side surface 130b of the circuit element 130. In addition, in this embodiment, the backlight module 100 further includes a reflective material 170. The reflective material 170 may be, for example, a white glue, a white paint, other suitable reflective materials, or a combination of the above, but is not limited thereto. The reflective material 170 may be provided and coated on the top surface 130a of the circuit element 130, so that at least a portion of the surface (e.g., the top surface 130a) of the circuit element 130 is made reflective. Accordingly, the mura of the display device resulting from the exposure of the circuit element can be improved, or the display device can exhibit a more uniform brightness.

In summary of the above, in the backlight module and the display device of the embodiment of the disclosure, since the circuit element and the light-emitting element are both disposed on the same surface (e.g., the first surface) of the substrate, compared to a backlight module in which the circuit element and the light-emitting element are respectively disposed on different surfaces (e.g., a first surface and a second surface opposite to each other) of the substrate, the backlight module and the display device of this embodiment can have a smaller thickness or can conform to a thin design. In addition, the approach of covering the circuit element by the protrusion of the reflective sheet, or the approach of coating the top surface of the circuit element with the reflective material can improve the mura of the display device resulting from the exposure of the circuit element or can provide a more uniform brightness in the display device.

Finally, it should be noted that the foregoing embodiments are merely used for describing the technical solutions of the disclosure, but are not intended to limit the disclosure. Although the disclosure has been described in detail with reference to the foregoing embodiments, a person of ordinary skill in the art should understand that modifications may still be made to the technical solutions in the foregoing embodiments, or equivalent replacements may be made to part or all of the technical features; and these modifications or replacements will not cause the essence of corresponding technical solutions to depart from the scope of the technical solutions in the embodiments of the disclosure.

What is claimed is:

1. A backlight module, comprising:
a substrate;
a plurality of light-emitting elements bonded onto the substrate;
a plurality of circuit elements bonded onto the substrate and electrically connected to the plurality of light-emitting elements, wherein at least four of the plurality of light-emitting elements are disposed around one of the plurality of circuit elements; and
a reflective sheet disposed on the substrate and having a plurality of first openings, wherein the plurality of first openings at least expose the plurality of light-emitting elements,
wherein the reflective sheet further comprises a plurality of protrusions, the plurality of protrusions are disposed corresponding to positions of the plurality of circuit elements, and the plurality of protrusions cover the plurality of circuit elements,
wherein one of the plurality of protrusions has an opening, the opening is formed of two crossing slits, extending directions of the two crossing slits are respectively parallel to extending directions of two edges of the plurality of circuit elements, and the extending directions of the two crossing slits do not cross the at least four of the plurality of light-emitting elements in a top view of the backlight module,
wherein the one of the plurality of protrusions corresponds to the one of the plurality of circuit elements in the top view of the backlight module,
wherein the at least four of the plurality of light-emitting elements are closer to the one of the plurality of the circuit elements than other of the plurality of light-emitting elements.

2. The backlight module according to claim 1, wherein the plurality of protrusions have a two-by-two-grid shape.

3. The backlight module according to claim 1, wherein vertices of the plurality of protrusions correspond to vertices of the plurality of circuit elements.

4. The backlight module according to claim 1, wherein the plurality of protrusions have a perforated line, and the perforated line is provided corresponding to edges of the plurality of protrusions.

5. The backlight module according to claim 4, wherein the perforated line is multiple discontinuous indentations formed on the edges of the plurality of protrusions.

6. The backlight module according to claim 1, wherein edges of the plurality of protrusions correspond to and are parallel to edges of the plurality of circuit elements.

7. The backlight module according to claim 1, wherein the plurality of protrusions and the reflective sheet are integrally formed.

8. The backlight module according to claim 1, wherein the plurality of circuit elements comprise a driving IC, a gate driver, a capacitor, or a resistor.

9. The backlight module according to claim 1, wherein the plurality of circuit elements and the plurality of light-emitting elements are disposed on a same surface of the substrate.

10. The backlight module according to claim 1, wherein a material of the reflective sheet is a white polyester.

11. The backlight module according to claim 1, wherein the substrate comprises a pad and another pad, the plurality of light-emitting elements are bonded onto the substrate via the pad, and the plurality of circuit elements are bonded onto the substrate via the another pad.

12. A display device comprising:
a backlight module, comprising:
a substrate;
a plurality of light-emitting elements bonded onto the substrate;
a plurality of circuit elements bonded onto the substrate and electrically connected to the plurality of light-emitting elements, wherein at least four of the plurality of light-emitting elements are disposed around one of the plurality of circuit elements; and
a reflective sheet disposed on the substrate and having a plurality of first openings,
wherein the plurality of first openings at least expose the plurality of light-emitting elements; and
a display panel disposed on the backlight module,
wherein the reflective sheet further comprises a plurality of protrusions, the plurality of protrusions are disposed corresponding to positions of the plurality of circuit elements, and the plurality of protrusions cover the plurality of circuit elements,
wherein one of the plurality of protrusions has an opening, the opening is formed of two crossing slits, extending directions of the two crossing slits are respectively parallel to extending directions of two edges of the plurality of circuit elements, and the extending directions of the two crossing slits do not cross the at least four of the plurality of light-emitting elements in a top view of the backlight module,
wherein the one of the plurality of protrusions corresponds to the one of the plurality of circuit elements in the top view of the backlight module,
wherein the at least four of the plurality of light-emitting elements are closer to the one of the plurality of the circuit elements than other of the plurality of light-emitting elements.

13. The display device according to claim 12, wherein the backlight module further comprises a diffuser and an optical film, wherein the diffuser is disposed on the substrate, and the optical film is disposed on the diffuser.

14. The display device according to claim 13, wherein the diffuser is located between the display panel and the substrate, and a distance between the diffuser and the substrate is less than or equal to 5 mm.
